(19) United States
(12) Patent Application Publication
(10) Pub. No.: US 2026/0071696 A1
(43) Pub. Date: Mar. 12, 2026

(54) STRUT CLAMP WITH INTEGRAL SADDLE

(71) Applicant: ERICO International Corporation, Solon, OH (US)

(72) Inventors: Scott Ernest Anderson, Garrettsville, OH (US); Lauren Novak, Strongsville, OH (US)

(21) Appl. No.: 19/309,092

(22) Filed: Aug. 25, 2025

Related U.S. Application Data
(60) Provisional application No. 63/691,484, filed on Sep. 6, 2024.
(60) Provisional application No. 63/817,058, filed on Jun. 3, 2025.

(51) Int. Cl. F16L 3/08; H02G 3/32

(52) U.S. Cl. CPC F16L 3/08; H02G 3/32

(57) ABSTRACT

A clip that secures conduit to strut may include a first leg with a first hook at a distal end thereof to engage the strut, a second leg with a second hook at a distal end thereof to engage the strut, a strap that extends between and integrally connects to a proximal end of the first leg and a proximal end of the second leg. The strap and the first and second legs can define an internal channel to receive the conduit. The clip may also include a saddle that extends integrally and moveably from the first leg into the internal channel to secure conduit within the internal channel, between the saddle and the strut.

### CROSS-REFERENCE TO RELATED APPLICATION

This application claims priority to U.S. Provisional Ser. No. 63/817,058 , filed Jun. 3, 2025, and U.S. Provisional Ser. No. 63/691,484 , filed Sep. 6, 2024, the entirety of which are incorporated herein by reference.

### BACKGROUND

In many applications it may be useful to support objects on a strut channel. For example, it may be useful to support raceways, conduit, including electric metallic tube (EMT) conduit, or cable, including metal clad (MC) cable and cable for data transmission, on a strut channel. In some contexts, other types of pipes, for instance, plumbing or gas pipes, need to be supported on strut channel.

### SUMMARY

Some embodiments of the invention provide a clip to secure conduit to strut that may include a first leg with a first hook at a distal end thereof to engage the strut, a second leg with a second hook at a distal end thereof to the strut, and a strap that extends between and integrally connects to a proximal end of the first leg and a proximal end of the second leg. The strap and the first and second legs can define an internal channel to receive the conduit. The clip can also include a saddle that extends integrally and movably from the first leg into the internal channel to secure conduit within the internal channel, between the saddle and the strut.

In some examples, the saddle can be cantilevered from the first leg and extends to a free end. The clip may further include a threaded fastener that extends through the strap to engage a free end of the saddle. The threaded fastener can be threadedly adjustable relative to the strap to urge the saddle into engagement with the conduit within the internal channel. With the first and second hooks engaging the strut, advancing the threaded fastener through the strap can urge the saddle toward the strut. The threaded fastener can be offset toward the second leg relative to a centerline for the conduit that is defined by the internal channel. The free end of the saddle may include one or more of an opening that retains the threaded fastener or a bend that retains the threaded fastener. The strap can include a seat portion that extends from the second leg and receives the threaded fastener and one or more arms that provide an arcuate connection between the seat portion and the second leg. The one or more arms may include a first arm and a second arm. The saddle can be formed from material between the first and second arms, to define a gap between the first and second arms. The first and second hooks can be aligned to engage a common lip of the strut. The first hook may be aligned to engage a first lip of the strut, and the second hook may be aligned to engage a second lip of the strut, opposite the first lip.

Some embodiments of the invention provide a method of securing a conduit to a strut. The conduit may be aligned relative to the strut. A clip can be aligned relative to the conduit with a first leg of the clip on a first side of the conduit, a distal end of the first leg having a first hook, a second leg of the clip on a second side of the conduit, a distal end of the second leg having a second hook, a strap integrally extending from a proximal end fo the first leg and a proximal end of the second leg to connect the first leg and the second leg together, and a saddle extending integrally from the first leg into the internal channel to engage the conduit. The strap and the first and second legs may define an internal channel that receives the conduit. The conduit can be secured to the strut by engaging the first hook with the strut, engaging the second hook with the strut, and moving the saddle within the internal channel to secure the conduit within the internal channel, between the saddle and the strut.

In some examples, one of the first and second hooks can be engaged with a first lip of the strut, or the first hook is engaged with the first lip of the strut and the second hook is engaged with a second lip of the strut that is opposite the first lip. The saddle can be urged into the conduit by advancing a threaded fastener that is threadedly engaged with the clip, to urge the threaded fastener into the saddle. The threaded fastener may be advanced toward the saddle with the threaded fastener offset toward the second leg relative to a centerline of the conduit within the internal channel. The threaded fastener can be advanced toward the saddle through a seat portion of the strut. A protrusion or a recess may be nested together on the first leg with a corresponding recess or protrusion, respectively, on a leg of an adjacent clip to gang the clip and the adjacent clip together on the strut.

Some embodiments of the invention provide a clip to secure conduit which includes a clip body that integrally includes a first leg with a first hook, a second leg with a second hook, a bridge portion that connect the first leg to the second leg to define an internal channel, a saddle that is cantilevered from the first leg to extend into the internal channel, and a fastener movably engaged with the bridge portion to urge the saddle towards the first and second hooks within the internal channel.

In some examples, the fastener can engage a free end of the saddle at a location that is offset towards the second leg from a centerline of the internal channel. The bridge portion may include a first arm and a second arm that extend between the first leg and the second leg. The saddle may align between the first arm and the second arm.

### BRIEF DESCRIPTION OF THE DRAWINGS

The accompanying drawings, which are incorporated in and form a part of this specification, illustrate embodiments of the invention and, together with the description, serve to explain the principles of embodiments of the invention:

FIG. 1 is an axonometric view of a clip to secure conduit or other components to strut, according to one embodiment of the invention;

FIG. 2 is a side elevation view of the clip of FIG. 1 in an engaged orientation on a strut, to secure a length of conduit;

FIG. 3 is an axonometric view of another configuration of the clip of FIG. 1 in a staging orientation to secure a length of conduit;

FIG. 4 is an axonometric view of another configuration of the clip of FIG. 1 in an engaged orientation to secure a length of conduit;

FIG. 5 an axonometric view of another embodiment of a clip to secure conduit or other components to strut;

FIG. 6 is a side elevation view of the clip of FIG. 5 in an engaged orientation;

FIG. 7 is an axonometric view of another configuration of the clip of FIG. 1;

FIG. 8 is an axonometric view of three clips of FIG. 7 in a ganged engaged orientation to secure lengths of conduit; and

FIG. 9 is a detail axonometric top view of area IX of FIG. 8.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

In different contexts, it may be useful to secure an object (e.g., pipes, tubes, cable, conduit, etc.) to a support structure, such as a strut channel. For example, an object may be secured to a strut channel for support using a clip. The support can be overhead, vertical, or horizontal along a wall, along the ground, or any other orientation. This support from the clips, for example, may be required to be spaced at certain maximum distances by code. As a result, numerous clips may need to be installed for a given installation, which can be time consuming and arduous.

Conventional arrangements for securing conduit can include multiple pieces that need to be individually installed within the strut channel on both sides of the object, after which a fastener, typically a bolt or screw, is received by both pieces and secured by tightening with a nut. With these types of clips, especially if installed overhead, the user may be required to perform much of the labor in ergonomically difficult positions (e.g., with hands above the head). With numerous parts and tools required, there is also a greater potential for dropping the parts and the tools, potentially leading to lost pieces, delayed installation, or other issues.

Examples of the disclosed technology can address these or other issues to provide improved installation/un-installation operations for objects and corresponding strut channels using a clip. For example, a clip can be an integrally formed unitary piece, with integrally extending legs and saddles cooperatively securing a length of conduit or other object to a strut or other support. Providing such a can be beneficial in many contexts. For example, objects can be secured to a strut channel with little to zero effort other than holding the object in place (as needed), pushing the clip into engagement with a strut channel to partially secure the object, and then advancing a fastener through the clip to further secure the object to the strut.

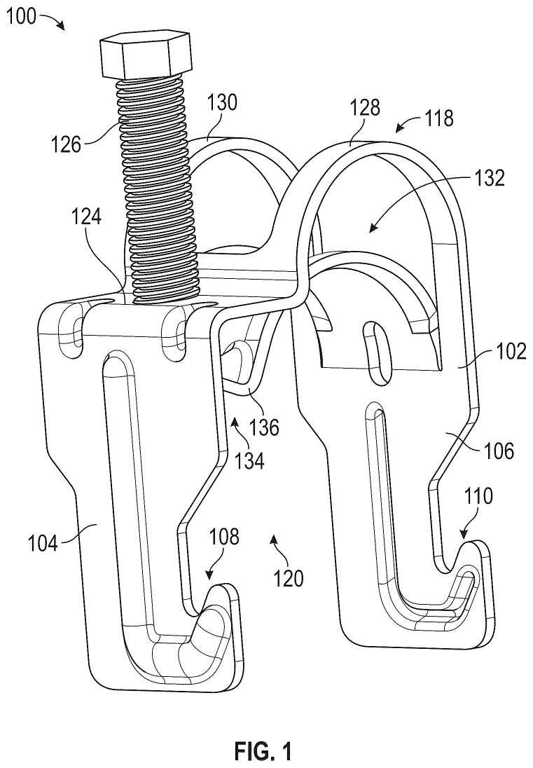

FIG. 1 illustrates an example clip 100 according to an embodiment of the present invention. The clip 100 includes a clip body 102 with two legs 104, 106 (e.g., a first leg and a second leg) extending opposite each other from the clip body 102 (e.g., in parallel). (As more generally noted below, “first” and “second” in this are used solely for clarification and identification purposes, and do not imply any particular order, sequence, or priority.) In this example, the legs 104, 106 are configured to provide structural support and position of the clip 100 and may be dimensioned to accommodate various strut configurations and installation requirements.

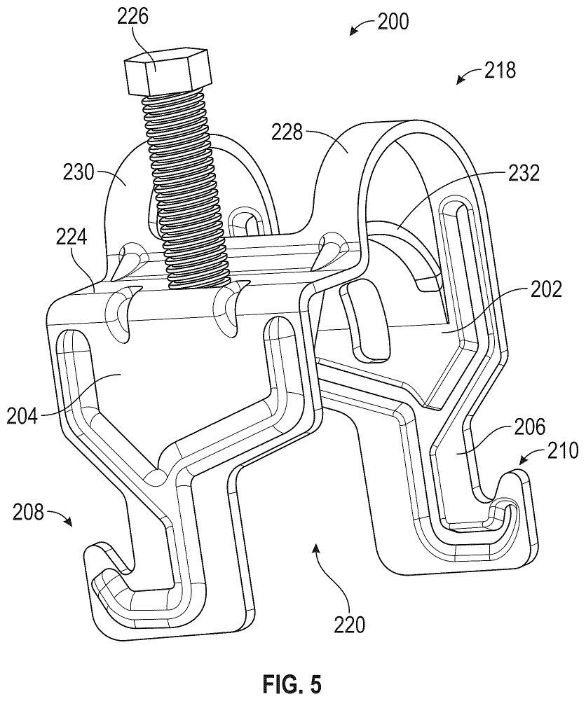

In some examples, as shown in FIG. 1, a hook 108, 110 (e.g., a curved hook, as shown) is configured to engage reentrant lips 112, 114 of a strut (not shown in FIG. 1) to secure the clip 100 at the reentrant lips 112, 114. In some examples, as shown, the hooks 108, 110 can be integrally formed at distal ends of the corresponding leg, for ease of insertion into and engagement with standard strut profiles. In the illustrated embodiment, the hooks 108, 110 face the same direction and are configured to engage with the same lip of a strut at different locations along the strut (as also discussed below). This arrangement creates multiple points of contact, spaced along one lip the strut, for improved hold and stability. However, other configurations are possible, including as further detailed relative to the example of FIG. 5.

The clip 100 can be formed from a resilient material, such as spring steel, alloy steel, stainless steel, or silicon-manganese steel, for example, although other configurations are possible. In the illustrated embodiment, the clip body 102 is a unitary object, integrally formed from one piece of material (e.g., as an integral stamping). However, it is contemplated that a clip according to another embodiment can be formed from an assembly of individual pieces and coupled together during the manufacturing process (e.g., with welding, molding, soldering, etc.).

The clip 100 may also include a bridge portion configured as a strap 118 that extends between the first leg 104 and the second leg 106 so that the strap 118 and the legs 104, 106 define an internal channel 120 that can receive and secure an object (e.g., a conduit or other elongate object) to channel strut. In the illustrated embodiment, the internal channel 120 is shown opening in a downward direction, although a variety of other orientations are possible. Similarly, although the internal channel 120 and the clip 100 generally are sized by a spacing and a depth of the legs 104, 106 to match a particular conduit size and a standard strut width, respectively, some embodiments can be configured to engage other types of support structures or other elongate objects (e.g., other cylindrical components).

As shown in the example of FIG. 1, the strap 118 may form a seat portion 124 configured to support application of force onto a saddle, as further discussed below. In the example shown, the seat portion 124 has a flat profile, with appropriate gusset reinforcement, to form a shelf of the bridge portion that is adjacent to the first leg 104. In some embodiments, the seat portion 124 can be formed adjacent to the second leg 106. In some examples, including as shown, the seat portion 124 may extend perpendicularly to the first leg 104, to help support and distribute fastener loads during installation. However, other configurations such as angled or curved profiles are possible, or various other contours.

As shown in FIG. 1, the seat portion 124 can receive a fastener 126 (e.g., a threaded fastener) for installation, as will be further discussed below. In other embodiments, the seat portion 124 may accommodate various types of fasteners, including screws, bolts, or other mechanical fastening elements that can be advanced relative to (e.g., through) the seat portion to apply retention force to a saddle. In some instances, however, a fastener may not be needed.

In the illustrated embodiment, the strap 118 further includes two arms 128, 130 that provide a connection over the internal channel 120 and between the seat portion 124 and the second leg 106. In the illustrated example, each of the arms 128, 130 exhibit arcuate profiles, although other configurations are possible. Such a multi-arm arrangement can allow more flexibility of the strap 118 during installation, while also allowing beneficially located material of the integrally formed clip 100 to be formed for use as a saddle rather than as part of a bridge portion (as also discussed below).

Continuing, in the illustrated example, a saddle 132 extends from the second leg 106 toward the first leg 104, into the internal channel 120. Generally, the saddle 132 can be concave toward an open end of the internal channel 120 (i.e., towards the distal ends of the legs 104, 106), so as to engage and secure a length of conduit or other object received into the channel 120. In different examples, the saddle 132 can accordingly be curved, angled (e.g., V-shaped) or otherwise concave. In the illustrated example, the saddle 132 is partially cylindrically shaped (i.e., includes a partially circular cross section), so as to closely engage a circular object profile (e.g., for standard conduit) for more secure engagement of the object when installed. Generally, different configurations of the saddle 132 according to the invention can accommodate different sizes of cylindrical objects or other elongate objects to be secured by the clip 100.

In the illustrated embodiment, the saddle 132 extends integrally from the second leg 106, and has a free end 134 that extends toward the first leg 104. Further, as noted above, the saddle 132 is integrally formed from material that originates between the arms 128, 130 of the strap 118 (i.e., is cut out of material that will become the bridge portion of the clip 100). As noted above, in other embodiments, the saddle 132 (e.g., and free end 134) can extend from the first leg 104 to the second leg 106. Thus, generally, the saddle 132 can be integrally cantilevered from one side of the clip body 102 to extend into the internal channel 120 toward the opposite side of the clip body 102 (i.e., to extend as a cantilevered member between opposing legs of the clip). Correspondingly, the saddle 132 can be oriented to engage with and secure a conduit or other object that is received into the internal channel 120 to secure the conduit or other object relative to a strut (or other support) engaged by the clip 100 (e.g., as assisted by engagement of a fastener with the saddle 132, as further detailed below).

The free end 134 of the saddle 132 may have an opening to engage a fastener(e.g., of various types, as noted above). For example, an opening may be located on or formed by a V-shaped bend 136 of the saddle 132, proximate to the first leg 104 and below the seat portion 124. In use, such an opening can align with the seat portion 124 of the strap 118 to engage the fastener 126. The geometry of the saddle 132 can thereby help to secure the fastener 126 in engagement with the saddle 132, when the fastener 126 is inserted through the seat portion 124 to clamp the saddle 132 onto the relevant object.

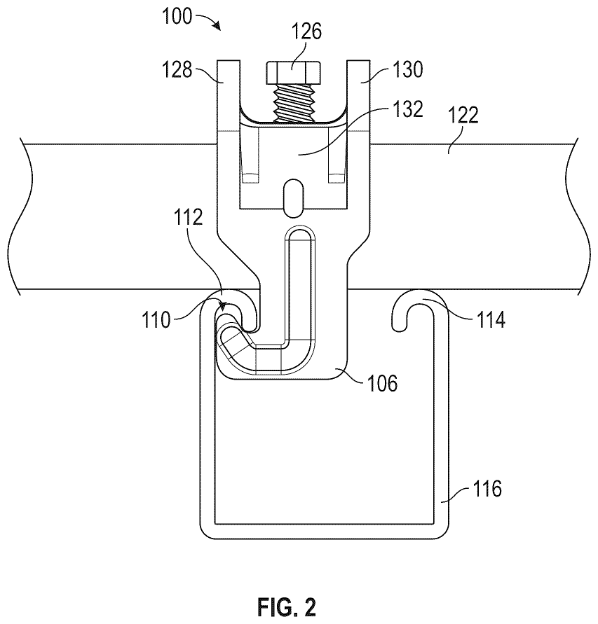

FIG. 2 illustrates the clip 100 in an engaged orientation. As shown, in the engaged orientation, the clip 100 is secured to the strut 116 which further secures the conduit 122 perpendicular to the strut 116. However, other objects such as pipes, tubes, cables, etc. may be similarly secured by the clip 100 or other clips according to the disclosed technology. To position the clip 100 in the engaged orientation, the conduit 122 is positioned to be received within the internal channel 120 of the clip 100, the clip 100 is engaged with the strut 116. As appropriate, the fastener 126 is then tightened to clamp the conduit 122 between the saddle 132 and the strut 116, within the internal channel 120. In particular, in the illustrated examples, during installation, the saddle 132 can be urged by the fastener 126 in a direction towards the hooks 108, 110, although other configurations are possible.

More specifically, the saddle 132 can be aligned over the conduit 122, for example, with the conduit 122 already resting on the strut 116. As noted above and further shown, the hooks 108, 110 clasp into the same lip 112 on the same side of the strut 116. Accordingly, the clip 100 can be angled relative to vertical and then rotated about a horizontal pivot axis (or otherwise manipulated) to engage the hooks 108, 110 underneath the lip 112. Once the conduit 122 is in the desired position relative to the strut 116, a user may rotate the fastener 126 in a first direction (e.g., clockwise) or otherwise advance the fastener 126 through the seat portion 124 of the clip 100, to urge the fastener 126 into the saddle 132 and thereby further secure the conduit 122 on the top of the strut 116. As noted above, for example, the fastener 126 can engage the saddle 132 at the bend 136, or otherwise at an opening on the saddle 132 to help retain the fastener 126 on the saddle 132 for appropriate application of force to the conduit 122.

As the fastener 126 is advanced through the seat portion 124 (e.g., downward as shown), the hooks 108, 110 are pulled upwards against the lip 112 of the strut 116 by resilient response of the saddle 132 in engagement with the conduit 122. Advantageously, the downward force of the fastener 126 is distributed through the saddle 132 along a distributed area on the conduit 122 to eliminate point loading of (and by) the clip 100 and improve fatigue resistance of the clip 100. Additionally, because the fastener 126 is off-centered relative to a vertical centerline of the conduit 122, at the distal end of the saddle 132 (see also FIG. 1), tightening the fastener 126 may tend to urge the conduit 122 more into secure engagement with the saddle 132 (e.g., rather than applying forces that might urge the conduit 122 to slip past the distal end of the saddle 132 or into other misalignment). In other words, the illustrated off-center positioning may create a self-centering effect that positions (and maintains) the conduit in an optimal location as the fastener 126 is tightened.

As noted above, in some examples, a fastener may not be required to secure conduit or other components. For example, the resilient response of a saddle to engagement with a conduit or other component as a clip is urged into engagement with a strut may be sufficient in some cases to appropriately secure the conduit or other component to the strut.

Favorably, the integral strap 118 and saddle 132 design of the clip 100 may also help to prevent movement (e.g., rotation) that may misalign the saddle 132 relative to the conduit 122 and the internal channel 120 during the engaging process. This aspect of the disclosed technology, for example, can help to ensure the conduit 122 is perpendicular to the strut 116 and the internal channel 120 once engaged (or otherwise appropriately aligned). As further shown in FIG. 2, the fastener 126 may be level with (or below) the top of the arms 128, 130 of the strap 118 at full installation, when the conduit 122 is secured onto the strut 116 and the hooks 108, 110 are engaged with the reentrant lip 112 of the strut 116. This alignment can provide a visual reference to an installer to indicate proper installation of the fastener 126 relative to the clip 100. Further, with such an arrangement, a total vertical rise of the clip 100, as installed, may accordingly be relatively small, which can create an overall lower profile of the clip 100.

To disengage the conduit 122 from the strut 116 and release the clip 100 from the strut 116 and the conduit 122, a user may rotate the fastener 126 in a second direction (e.g., counterclockwise) or otherwise withdraw the fastener. As the fastener 126 is rotated in the second direction, the saddle 132 can accordingly be permitted to resiliently rise off of the conduit 122 (e.g., upwardly, as shown). The hooks 108, 110 can also thus be released from responsive forces urging the hooks 108, 110 into the lip 112, and can accordingly be disengaged from the lip 112 (e.g., partly or fully). With the clip 100 thus loosened (or removed), the conduit 122 may then be removed or otherwise adjusted (e.g., slid laterally) relative to the strut 116. This sliding adjustment, in particular, which may be possible with the clip 100 still staged on the strut 116 and around the conduit 122, can allow for improved ease of fine-tuning of the positioning of the conduit 122 during installation.

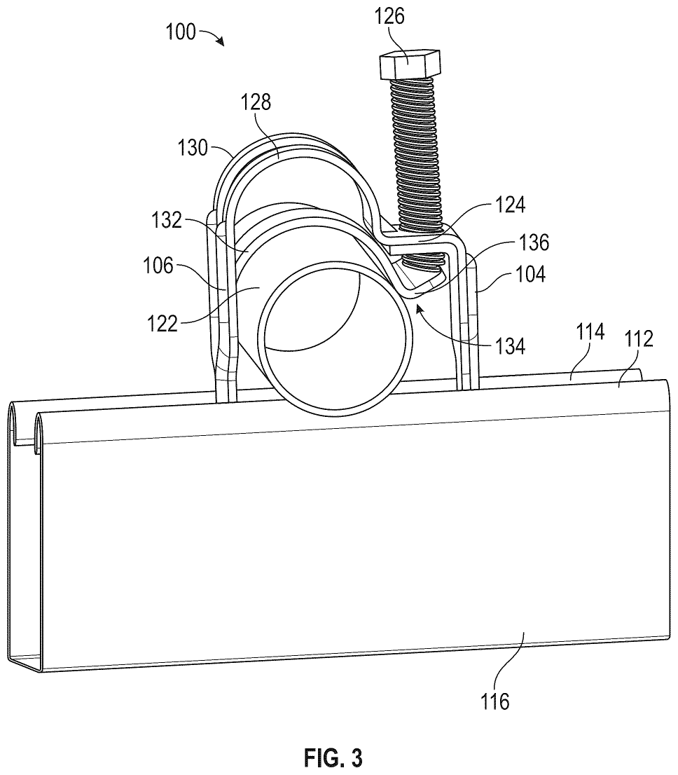

Referring now to FIG. 3, another configuration of the clip 100 is shown in a staging orientation, part way through an installation process for the clip 100. Generally, the clip 100 of FIG. 3 is the same as the clip 100 of FIG. 1, and previous discussion of clip 100 thus also applies to the clip 100 of FIG. 3 unless otherwise indicated.

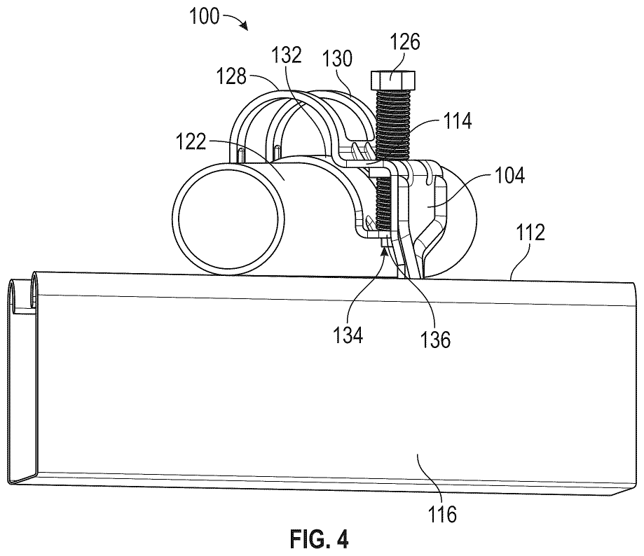

In particular, the fastener 126 is received in the seat portion 124 on a side of the conduit 122 that aligns the fastener 126 with the free end 134 of the saddle 132 at a location that is off-center on the conduit 122. As such, the net forces on the conduit 122 as the fastener 126 is advanced downward will urge the conduit 122 further into engagement under the saddle 132 (e.g., rather than potentially urge the conduit 122 to slip past the free end 134 and out of engagement with the saddle 132). In other embodiments, however, the clip 100 may not have the seat portion 124. For example, the fastener 126 may be extend from the strap 118 to engage at the center of the saddle 132 or may extend from the strap 118 in the center of the internal channel 120 (e.g., may extend from material that is within the gap illustrated between the arms 128, 130 in FIG. 4, as can be provided through the use of a shorter saddle). Further in other embodiments, the clip 100 may be secured to the conduit 122 and the strut 116 without the use of a fastener (e.g., due to sufficient resilient response of the saddle 132 when engaged with the conduit 122 to urge the hooks 108, 110 into engagement with the strut 116).

FIG. 4 shows another configuration of the clip 100 in an engaged orientation to secure the conduit 122. Generally, the clip 100 of FIG. 4 is the same as the clip 100 of FIG. 3, and previous discussion of clip 100 thus also applies to the clip 100 of FIG. 3 unless otherwise indicated below.

As compared to the staging orientation shown in FIG. 3, the saddle 132 has been urged downward by the fastener 126 to extended over a longer circumferential distance of the conduit 122 (and corresponding greater areal percentage), which can prevent localized stress concentrations, as noted above.

In particular, in FIG. 4, and in contrast to the configuration of FIG. 3, it can be seen that the fastener 126 may extend at least partly through the opening of the saddle 132 to help retain the fastener 126 during operation. Further, as shown, as the clip 100 is tightened to secure the saddle 132 to the conduit 122, angular deflection of the saddle 132 can move the V-shaped bend 136 of the saddle 132 to be less sharply angled (e.g., flatter) relative to the axis of the fastener 126. In this light, for example, extending the fastener 126 through the opening (as shown) can provide further security against the fastener 126 slipping off of the saddle 132 at high clamping forces or in installations with significant angular deflection of the saddle 132 between staging and installed configurations. In some examples, as also discussed above, the opening (e.g., on the bent free end 134, as shown) can be a through hole, detent, or depression to receive the fastener 126, however other configurations are possible. Alternative configurations may include threaded openings, captured nuts, or spring-loaded mechanisms, although other examples are contemplated.

FIG. 5 shows a clip 200, as another configuration of the clip 100 that can secure conduit to strut. As shown, clip 200 is generally similar to clip 100. For example, the clip 200 similarly has two parallel legs 204, 206 that extend form a clip body 202, an internal channel 220 to receive conduit and defined by the legs 204, 206 in combination with a bridge portion that includes a strap 218, a saddle 232 with a free end (hidden from view) extending into the internal channel 220 between the first leg 204 and the second leg 206, a seat portion 224 formed from the strap 218 perpendicular to the first leg 204 that receives a threaded fastener 226. In particular, the strap 218 has two arms 228, 230 extending from the first leg 204 to the second leg 206. Furthermore, the threaded fastener 226 is received through the seat portion 224 to engage the free end of the saddle 232 and secure the conduit 222 to the strut 216. Similar to the clip 100, each leg 204, 206 has a hook 208, 210 at a distal end of the clip 200. Accordingly, discussion of the clip 100 above also applies to similarly labeled or numbered parts of the clip 200 (in the 200 series, rather than the 100 series), unless otherwise specifically noted (and vice versa).

As one example difference relative to the clip 100, in the illustrated embodiment, the hooks 208, 210 face different directions from each other (e.g., opening in opposite axial directions relative to a secured conduit, in the example shown). Accordingly, the hooks 208, 210 can engage with different (e.g., opposed) lips of a strut in an engaged orientation.

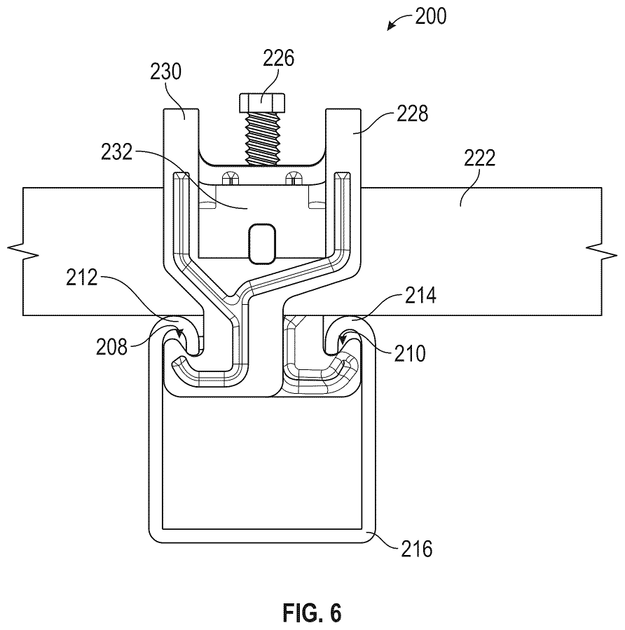

In this regard, FIG. 6 shows the clip 200 in an engaged orientation. In particular, as shown, the hooks 208, 210 are clasped to the interior sides of different lips 212, 214 of the strut 216. This engagement with different lips 212, 214 may provide enhanced stability by distributing retention forces across both sides of the strut 216. The saddle 232 is secured over the conduit 222 and the conduit 222 abuts exterior surfaces of the lips 212, 214 of the strut 216. As discussed above, the fastener 226 may be rotated in a first direction (e.g., clockwise) to urge the saddle 232 to engage with the top of the conduit 222 and thereby urge the conduit 222 onto top of the strut 216. Simultaneously, and responsively, the hooks 208, 210 can be urged (e.g., upward, as shown) to securely engage the lips 212, 214 of the strut 216, respectively.

In particular, to engage or disengage the clip 200 from the strut 216, the clip 200 can be rotated about a vertical axis (as shown). For example, to install the clip 200, the clip 200 can be oriented around the conduit 222 at an angular offset relative to the engaged orientation (i.e., relative to rotation about a vertical axis, as shown), then rotated against the angular offset to align the hooks 208, 210 with the lips 212, 214 of the strut 216. With appropriate sizing of the internal channel 220, the initial angular offset positioning may allow the clip 200 to be placed around the conduit 222 without interference from the strut 216, which can provide clearance for the hooks 208, 210 to engage the lips 212, 214 during continued installation.

As similarly discussed above, to disengage the clip 200 from the conduit 222 and the strut 216, the fastener 226 is rotated in a second direction (e.g., counterclockwise) to allow the saddle 232 to rise off of the conduit 222 and the hooks 208, 210 to be released from the lip 212 of the strut 216. Thus, as desired, the conduit 222 can be adjusted along or removed from the strut 216 (e.g., via a reversed rotation relative to the installation described above).

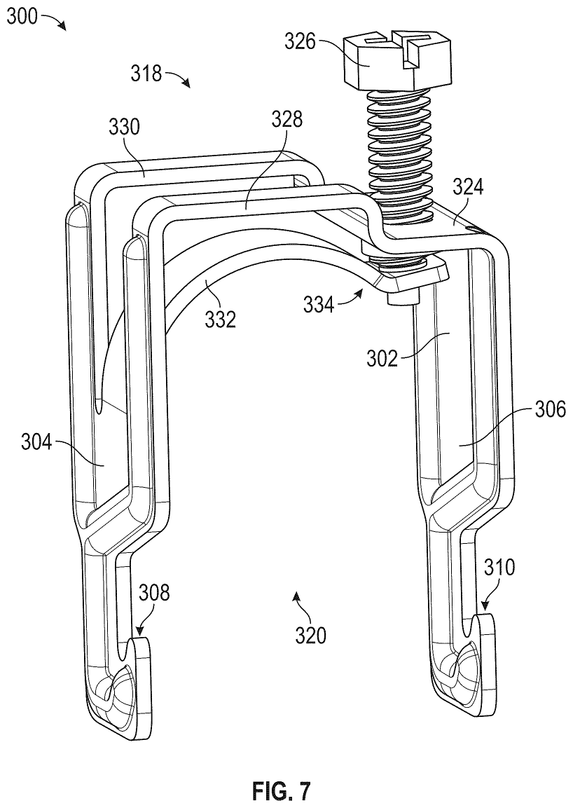

FIG. 7 shows a clip 300, as another configuration of the clip 100 that can secure conduit to a strut. As shown, the clip 300 is generally similar to clip 100. For example, the clip 300 similarly has two parallel legs 304, 306 that extend form a clip body 302, a saddle 332 with a free end 334 extending between the first leg 304 and the second leg 306, a bridge portion that includes a strap 318 and a seat portion 324 formed from a strap 318 perpendicular to the second leg 306, an internal channel 320 defined between the legs 304, 306 and the bridge portion that includes the saddle 332 and receives the conduit 322. In particular, the strap 318 has two arms 328, 330 extending from the first leg 304 to the second leg 306. Furthermore, the threaded fastener 326 is received through the seat portion 324 to engage the free end 334 of the saddle 332 and secure the conduit 322 to the strut 316. Similar to the clip 100, each leg 304, 306 has a hook 308, 310 at a distal end of the clip 300. Accordingly, discussion of the clip 100 above also applies to similarly labeled or numbered parts of the clip 300 (in the 300 series, rather than the 100 series), unless otherwise specifically noted (and vice versa).

As one example difference relative to the clip 100, in the illustrated embodiment, the clip body 302, and more particularly, the two arms 328, 330 define a square profile. Accordingly, the clip 300 has a lower protruding profile away from the relevant strut, which can improve space efficiency of the clip 300 when installed. Further, the square profile can create relatively high stiffness against deformation during use, to help provide further resistance to bending or twisting forces, distribute loads more effectively, and reduce stress concentrations that might lead to failure.

In the illustrated example, the hooks 308, 310 are configured to face the same direction so as to engage the same lip 312 of the strut 316. As further detailed below, this arrangement can facilitate close ganging of multiple instances of the clip 300, so that multiple clips 300 can be stacked together along the strut 316.

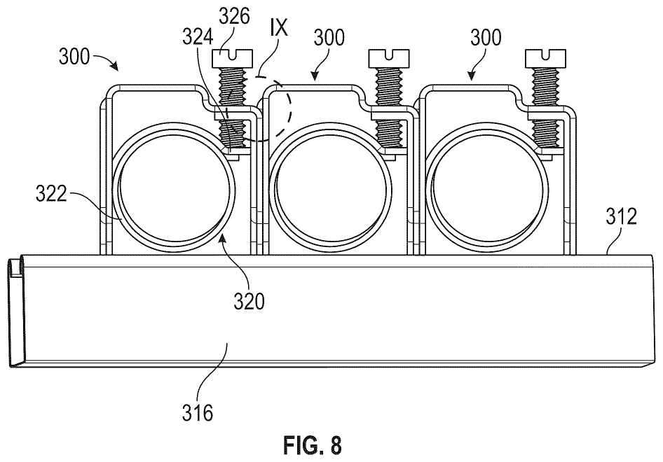

In this regard, turning now to FIG. 8, three of the clips 300 (i.e., three substantially identical instances of the clip 300) are shown in an installed orientation. In particular, three conduits 322 are received within respective ones of the internal channels 320 of the clips 300, and the fasteners 326 are advanced through each seat 324 of each clip 300 to secure the conduit 322 to the strut 316 (e.g., correspondingly moving the fasteners to be at or below a height of the bridge portion. To minimize space along the strut 316, the clips 300 are engaged with one another (e.g., nested or abutted together) at the legs 304, 306. In the illustrated example, each clip 300 is engaged with the strut 316 on the same lip 312, which may improve ease of installation for ganged assemblies, although other configurations are possible.

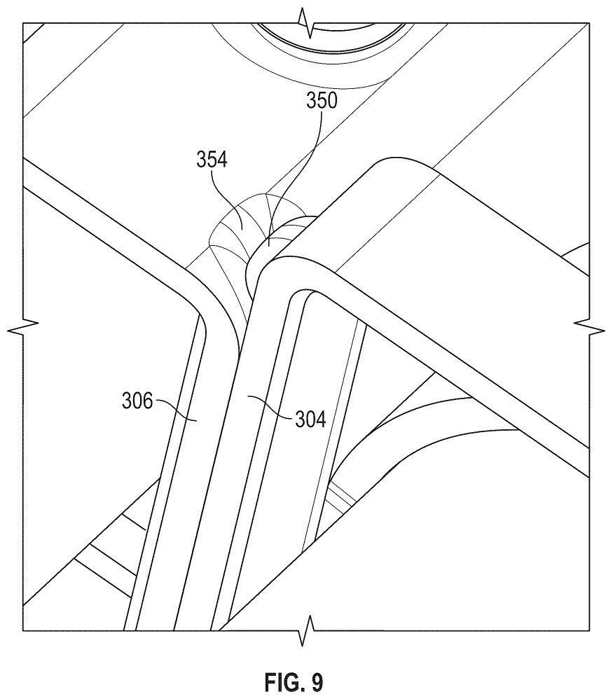

In different examples, corresponding protrusions and recesses can be provided on legs of clips, so that a recess on one clip can receive a protrusion on an adjacent (e.g., abutted) clip to help align and secure the clips in a ganged configuration (e.g., as shown in FIG. 8). Referring now to FIG. 9, for example, the first leg 304 has an outward projection 350 (e.g., an embossed rib, as shown) that is configured to engage a corresponding recess 354 (e.g., an embossed groove, as shown) of the second leg 306 of a different clip 300 that allow multiple clips 300 to be snugly fit together in a nested configuration. In other examples, the projection 350 may be on the second leg 306 and the recess 354 is on the first leg 304, or other configurations may be possible. Further, in other examples, nesting can be achieved through interlocking elements, overlapping sections, or other mechanical connections. Generally, nesting of adjacent clips can help to maximize available space by eliminating empty space between the clips 300 when concurrently installed along the same strut 316, as discussed above. Additionally, a nested configuration can increase overall stability of the clips 300 through the multi-axis inter-engagement of adjacent sets of the clips 300.

Thus, embodiments of the disclosure can provide for an improved mechanism for a clip configured to secure an object to a support structure. For example, a clip with a saddle and legs can easily secure the object to the support structure without the use of tools. In some embodiments, the clip can secure the object to the support structure via hooks on each leg.

The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

For convenience of presentation, in some figures that include multiple instances of similar features (e.g., multiple ribs, struts, or parts of a grating), only some of the similar features may be specifically indicated by reference number. One of skill in the art will recognize that the features not labeled with reference numbers can include similar aspects and perform similar functions to similar features that are labeled with reference numbers. Similarly, some features may be labeled with reference numbers in only select figures.

Also as used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “only one of,” or “exactly one of.” For example, a list of “only one of A, B, or C” indicates options of: A, but not B and C; B, but not A and C; and C, but not A and B. In contrast, a list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more A, one or more B, and one or more C. Similarly, a list preceded by “a plurality of” (and variations thereon) and including “or” to separate listed elements indicates options of one or more of each of multiple of the listed elements. For example, the phrases “a plurality of A, B, or C” and “two or more of A, B, or C” indicate options of: one or more A and one or more B; one or more B and one or more C; one or more A and one or more C; and one or more A, one or more B, and one or more C.

Also as used herein, unless otherwise limited or defined, “integral” and derivatives thereof (e.g., “integrally”) describe elements that are manufactured as a single piece without fasteners, adhesive, or the like to secure separate components together. For example, an element that is stamped, cast, or otherwise molded as a single-piece component from a single piece of sheet metal or other continuous single piece of material, without rivets, screws, other fasteners, or adhesive to hold separately formed pieces together, is an integral (and integrally formed) element. In contrast, an element formed from multiple pieces that are separately formed initially then later fastened together, is not an integral (or integrally formed) element.

Unless otherwise specified or limited, the terms “about” and “approximately,” as used herein with respect to a reference value, refer to variations from the reference value of ±20% or less (e.g., ±15, ±10%, ±5%, etc.), inclusive of the endpoints of the range. Similarly, as used herein with respect to a reference value, the term “substantially equal” (and the like) refers to variations from the reference value of ±5% or less (e.g., ±2%, ±1%, ±0.5%) inclusive. Where specified in particular, “substantially” can indicate a variation in one numerical direction relative to a reference value. In particular, the term “substantially less” than a reference value (and the like) indicates a value that is reduced from the reference value by 30% or more (e.g., 35%, 40%, 50%, 65%, 80%), and the term “substantially more” than a reference value (and the like) indicates a value that is increased from the reference value by 30% or more (e.g., 35%, 40%, 50%, 65%, 80%).

As used herein, unless otherwise limited or specified, “substantially identical” refers to two or more components or systems that are manufactured according to the same process and specification, with variation between the components or systems that are within the limitations of acceptable tolerances for the relevant process or specification. For example, two components can be considered to be substantially identical if the components are manufactured according to the same standardized manufacturing steps, with the same materials, and within the same acceptable dimensional tolerances (e.g., as specified for a particular process or product).

Also as used herein, unless otherwise specified or limited, “substantially parallel” indicates a direction that is within ±12 degrees of a reference direction (e.g., within ±6 degrees or ±3 degrees), inclusive. Similarly, unless otherwise specified or limited, “substantially perpendicular” similarly indicates a direction that is within ±12 degrees of perpendicular a reference direction (e.g., within ±6 degrees or ±3 degrees), inclusive. Correspondingly, “substantially vertical” indicates a direction that is substantially parallel to the vertical direction, as defined relative to the reference system (e.g., a local direction of gravity, by default), with a similarly derived meaning for “substantially horizontal” (relative to the horizontal direction). Discussion of directions “transverse” to a reference direction indicate directions that are not substantially parallel to the reference direction. Correspondingly, some transverse directions may be perpendicular or substantially perpendicular to the relevant reference direction.

Unless otherwise specifically indicated, ordinal numbers are used herein for convenience of reference, based generally on the order in which particular components are presented in the relevant part of the disclosure. In this regard, for example, designations such as “first,” “second,” etc., generally indicate only the order in which a thus-labeled component is introduced for discussion and generally do not indicate or require a particular spatial, functional, temporal, or structural primacy or order.

In some implementations, devices or systems disclosed herein can be utilized, manufactured, installed, etc. using methods embodying aspects of the disclosed technology. Correspondingly, any description herein of particular features, capabilities, or intended purposes of a device or system should be considered to disclose, as examples of the disclosed technology a method of using such devices for the intended purposes, a method of otherwise implementing such capabilities, a method of manufacturing relevant components of such a device or system (or the device or system as a whole), and a method of installing disclosed (or otherwise known) components to support such purposes or capabilities. Similarly, unless otherwise indicated or limited, discussion herein of any method of manufacturing or using for a particular device or system, including installing the device or system, should be understood to disclose, as examples of the disclosed technology, the utilized features and implemented capabilities of such device or system.

The previous description of the disclosed embodiments is provided to enable any person skilled in the art to make or use the invention. Various modifications to these embodiments will be readily apparent to those skilled in the art, and the generic principles defined herein may be applied to other embodiments without departing from the spirit or scope of the invention. Thus, the invention is not intended to be limited to the embodiments shown herein but is to be accorded the widest scope consistent with the principles and novel features disclosed herein.

1. A clip to secure conduit to strut, the clip comprising:
a first leg, with a first hook configured to engage the strut at a distal end of the first leg;
a second leg, with a second hook configured to engage the strut at a distal end of the second leg;
a strap that integrally connects the first and second legs together, the strap extending from a proximal end of the first leg and a proximal end of the second leg, and the strap and the first and second legs defining an internal channel configured to receive the conduit; and
a saddle that extends integrally and movably from the first leg into the internal channel to secure the conduit within the internal channel, between the saddle and the strut.

2. The clip of claim 1, wherein the saddle is cantilevered from the first leg and extends to a free end; and
wherein the clip further comprises:
a threaded fastener that extends through the strap to engage a free end of the saddle, the threaded fastener being threadedly adjustable relative to the strap to urge the saddle into engagement with the conduit within the internal channel.

3. The clip of claim 2, wherein, with the first and second hooks engaging the strut, advancing the threaded fastener through the strap urges the saddle toward the strut.

4. The clip of claim 2, wherein the threaded fastener is offset toward the second leg relative to a centerline for the conduit that is defined by the internal channel.

5. The clip of claim 4, wherein the free end of the saddle includes one or more of an opening that retains the threaded fastener or a bend that retains the threaded fastener.

6. The clip of claim 2, wherein the strap includes:
a seat portion that extends from the second leg and receives the threaded fastener; and
one or more arms that provide an arcuate connection between the seat portion and the second leg.

7. The clip of claim 6, wherein the one or more arms include a first arm and a second arm; and
wherein the saddle is formed from material between the first and second arms, to define a gap between the first and second arms.

8. The clip of claim 1, wherein the first and second hooks are aligned to engage a common lip of the strut.

9. The clip of claim 1, wherein the first hook is aligned to engage a first lip of the strut, and the second hook is aligned to engage a second lip of the strut, opposite the first lip.

10. The clip of claim 1, wherein the first leg includes a first protrusion or recess, and the second leg includes a second protrusion or recess;
wherein the first protrusion or recess is configured to nest with a first corresponding recess or protrusion, respectively, on an adjacent leg of a first adjacent clip, to gang the clip with the first adjacent clip; and
wherein the second protrusion or recess is configured to nest with a second corresponding recess or protrusion, respectively, on an adjacent leg of a second adjacent clip, to gang the clip with the second adjacent clip.

11. A method of securing a conduit to a strut, the method comprising:
aligning the conduit relative to the strut;
aligning a clip relative to the conduit, with:
a first leg of the clip on a first side of the conduit, a distal end of the first leg having a first hook;
a second leg of the clip on a second side of the conduit, a distal end of the second leg having a second hook;
a strap integrally extending from a proximal end of the first leg and a proximal end of the second leg to connect the first and second legs together, the strap and the first and second legs defining an internal channel that receives the conduit; and
a saddle extending integrally from the first leg into the internal channel to engage the conduit; and
securing the conduit to the strut by:
engaging the first hook with the strut;
engaging the second hook with the strut; and
moving the saddle within the internal channel to secure the conduit within the internal channel, between the saddle and the strut.

12. The method of claim 11, wherein one of:
the first and second hooks are engaged with a first lip of the strut; or
the first hook is engaged with the first lip of the strut and the second hook is engaged with a second lip of the strut that is opposite the first lip.

13. The method of claim 11, wherein the saddle is urged into the conduit by advancing a threaded fastener that is threadedly engaged with the clip, to urge the threaded fastener into the saddle.

14. The method of claim 13, wherein the threaded fastener is advanced toward the saddle with the threaded fastener offset toward the second leg relative to a centerline of the conduit within the internal channel.

15. The method of claim 14, wherein the threaded fastener is advanced toward the saddle through a seat portion of the strap.

16. The method of claim 11, further comprising:
nesting together a protrusion or a recess on the first leg with a corresponding recess or protrusion, respectively, on a leg of an adjacent clip to gang the clip and the adjacent clip together on the strut.

17. The method of claim 16, further comprising:
advancing a threaded fastener of the adjacent clip to move an integral saddle of the adjacent clip to secure additional conduit within an internal channel of the adjacent clip.

18. A clip to secure conduit, the clip comprising:
a clip body that integrally includes:
a first leg with a first hook;
a second leg with a second hook;
a bridge portion that connects the first leg to the second leg to define an internal channel;
a saddle that is cantilevered from the first leg to extend into the internal channel; and
a fastener movably engaged with the bridge portion to urge the saddle towards the first and second hooks within the internal channel.

19. The clip of claim 18, wherein the fastener engages a free end of the saddle at a location that is offset towards the second leg from a centerline of the internal channel.

20. The clip of claim 19, wherein the bridge portion includes a first arm and a second arm that extend between the first leg and the second leg; and
wherein the saddle is aligned between the first and second arms.
